(19) United States
(12) Patent Application Publication
(10) Pub. No.: US 2024/0375555 A1
(43) Pub. Date: Nov. 14, 2024

(54) SEAT CONTROL APPARATUS AND SEAT CONTROL METHOD

(71) Applicants: HYUNDAI MOTOR COMPANY, Seoul (KR); KIA CORPORATION, Seoul (KR)

(72) Inventors: Kug Hun Han, Seoul (KR); Yo Han Kim, Ansan-si (KR); Mun Seung Kang, Suwon-si (KR); Deok Soo Lim, Hwaseong-si (KR); Dong Hoon Lee, Hwaseong-si (KR)

(73) Assignees: HYUNDAI MOTOR COMPANY, Seoul (KR); KIA CORPORATION, Seoul (KR)

(21) Appl. No.: 18/620,608

(22) Filed: Mar. 28, 2024

(30) Foreign Application Priority Data
May 14, 2023 (KR) 10-2023-0062090
Oct. 4, 2023 (KR) 10-2023-0131886

(51) Int. Cl. B60N 2/02; B60N 2/20

(52) U.S. Cl. CPC B60N 2/0276; B60N 2/02246; B60N 2/0226; B60N 2/0272; B60N 2/20

(57) ABSTRACT

A seat control apparatus includes an input part, a driving part, a sensor part, a memory, and a controller. The seat control apparatus may receive, through the input part, a switch input for controlling a seat. The seat control apparatus may identify, using the sensor part, whether an escape mechanism for the seat is operated. The seat control apparatus may stop driving of at least one motor included in the driving part when the escape mechanism is operated.

### CROSS-REFERENCE TO RELATED APPLICATION

This application claims the benefit of and priority to Korean Provisional Application No. 10-2023-0062090, filed on May 14, 2023, and Korean Patent Application No. 10-2023-0131886, filed on Oct. 4, 2023, the entire contents of both of which are incorporated herein by reference.

### TECHNICAL FIELD

The present disclosure relates generally to a seat control apparatus and a seat control method. More particularly, the present disclosure relates to a technology for controlling a state of a seat when the seat is operated.

### BACKGROUND

The statements in this section merely provide background information related to the present disclosure and may not constitute prior art.

With the development of technologies, various components may be operatively connected in an interior of a vehicle. In particular, a seat control apparatus may provide various functions promptly and precisely by performing a cooperative control of components for convenience of a user.

For example, a vehicle may include a plurality of seats, and at least one of a reclining angle, a slide location, a tilting location, or any combination thereof may be controlled to control positions (or operation modes) of the plurality of seats.

Generally, when a vehicle confronts an emergency situation in a situation in which three or more seat rows are disposed in an interior of a vehicle (e.g., a situation shortly before a collision with an external object), passengers of a seat of row 1 or row 2 may escape to an outside of the vehicle promptly by opening doors corresponding to the row. However, passenger of a seat of row 3 may escape more slowly than the passengers of row 1 or row 2 due to a seat of row 2.

It is difficult to provide a function of supporting escape passages to support prompt escapes of passengers seated on a seat of row 3 when a vehicle is in an emergency situation. In particular, when a seat of row 2 is a seat a location control of which is performed by an electric motor, an operation, for example, of folding or sliding the seat of row 2 cannot be promptly performed.

Furthermore, to support the escape of passengers in an emergency situation, a mechanical escape mechanism may be activated, for example, by unfixing a recliner mounted on the seat, but when unexpected situations, such as driving of a motor for operating the recliner, occur in this situation, the escape speed targeted by the mechanical escape mechanism may not be achieved.

### SUMMARY

The present disclosure has been made to solve the above-mentioned problems occurring in the prior art while advantages achieved by the prior art are maintained intact.

An aspect of the present disclosure provides a seat control apparatus that stops driving of at least one motor included in a driving part when an escape mechanism of a seat is operated in a situation in which the seat control apparatus receives a switch input for controlling the seat from a user through an input part.

An aspect of the present disclosure provides a seat control apparatus that classifies at least one motor included in a driving part to a first motor and a second motor that are classified according to a user setting and/or a predefined classification reference. In an aspect, the seat control apparatus fully deactivates the first motor classified as a deactivation target when identifying that an escape mechanism is operated, and stops only driving of the second motor while maintaining the second motor not classified as a deactivation target in an activation state, thereby performing selective control.

An aspect of the present disclosure provides a seat control apparatus that identifies which motor an additional switch input corresponds to when receiving the additional switch input while different controls are performed on a first motor and a second motor. In an aspect, the seat control apparatus ignores the switch input according to a type of a corresponding motor to maintain a current state of a seat or perform a seat location control corresponding to the switch input.

An aspect of the present disclosure provides a seat control apparatus that ignores a switch input regardless of a type of a switch to maintain a current state of a seat according to a type of a switch that receives the switch input, or determines whether a seat control is to be performed after further identifying the type of the motor.

An aspect of the present disclosure provides a seat control apparatus that transmits an unlocking and/or opening request signal of at least one door in an interior of a host vehicle to an external device (e.g., a door control device) when identifying that an escape mechanism is operated.

An aspect of the present disclosure provides a seat control apparatus that transmits an output request signal of an audio regarding an escape mechanism to a sound output device, or transmits an accident occurrence identification request signal to an e-call system, when identifying that an escape mechanism is operated.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a seat control apparatus is provided. The seat control apparatus includes an input part, a driving part, a sensor part, a memory that stores one or more instructions, and a controller operatively connected to the input part, the driving part, the sensor part, and the memory. The instructions, when executed by the controller, cause the seat control apparatus to receive, through the input part, a switch input for controlling a seat. The instructions, when executed by the controller, further cause the seat control apparatus to identify, using the sensor part, whether an escape mechanism for the seat is operated. The instructions, when executed by the controller, additionally cause the seat control apparatus to stop driving of at least one motor included in the driving part when the escape mechanism is operated.

According to an embodiment, the instructions, when executed by the controller, may cause the seat control apparatus to perform a seat location control corresponding to the switch input by using the driving part when the escape mechanism is not operated.

According to an embodiment, the instructions, when executed by the controller, may cause the seat control apparatus to deactivate, among the at least one motor, a first motor classified as a deactivation target. The instructions, when executed by the controller, may additionally cause the seat control apparatus to stop driving of a second motor not classified as the deactivation target and maintain the second motor in an activation state.

According to an embodiment, the instructions, when executed by the controller, may cause the seat control apparatus to ignore a first additional switch input and maintain a current state of the seat when the first additional switch input corresponding to the first motor is received. The instructions, when executed by the controller, may additionally cause the seat control apparatus to perform a seat location control corresponding to a second additional switch input when the second additional switch input corresponding to the second motor is received.

According to an embodiment, the instructions, when executed by the controller, may cause the seat control apparatus to ignore the switch input and maintain a current state of the seat when the switch input is received from a first switch classified as a deactivation target.

According to an embodiment, the instructions, when executed by the controller, may cause the seat control apparatus to identify whether a motor corresponding to the switch input corresponds to the first motor when the switch input is received from a second switch which is not classified as the deactivation target or classified as an activation target. The instructions, when executed by the controller, may additionally cause the seat control apparatus to ignore the switch input and maintain the current state of the seat when the switch input received from the second switch corresponds to the first motor.

According to an embodiment, the instructions, when executed by the controller, may cause the seat control apparatus to perform a seat location control corresponding to a switch input by using the second motor when the switch input received from the second switch corresponds to the second motor.

According to an embodiment, the instructions, when executed by the controller, may cause the seat control apparatus to identify whether a recliner is unfixed, by using the sensor part disposed on one area being adjacent to the recliner for adjusting an angle of a backrest of the seat. The instructions, when executed by the controller, may additionally cause the seat control apparatus to identify whether the escape mechanism is operated when it is identified that the recliner is unfixed.

According to an embodiment, the instructions, when executed by the controller, may cause the seat control apparatus to identify whether a user setting regarding a cooperation request mode is an on state. The instructions, when executed by the controller, may additionally cause the seat control apparatus to identify whether a travel speed of a host vehicle and an operation state of a collision detecting sensor included in the sensor part satisfy specific conditions when the user setting is an on state. The instructions, when executed by the controller, may further cause the seat control apparatus to transmit at least one door unlocking or opening request signal of the host vehicle to an external device when the travel speed and the operation state of the collision detecting sensor satisfy the specific conditions.

According to an embodiment, the instructions, when executed by the controller, may cause the seat control apparatus to transmit an output request signal of an audio regarding the escape mechanism to a sound output device or transmit an accident occurrence identification request signal to an e-call system when it is identified that the escape mechanism is operated.

According to another aspect of the present disclosure, a seat control method is provided. The seat control method includes receiving, by a controller, a switch input for controlling a seat. The switch input may be provided by a user through an input part, for example. The seat control method may also include identifying, by the controller, using a sensor part, whether an escape mechanism for the seat is operated. The seat control method may additionally include stopping, by the controller, driving of at least one motor included in a driving part when the escape mechanism is operated.

According to an embodiment, the seat control method may further include performing, by the controller, a seat location control corresponding to the switch input by using the driving part when the escape mechanism is not operated.

According to an embodiment, stopping the driving of the at least one motor included in the driving part when the escape mechanism is operated may include deactivating, by the controller, among the at least one motor, a first motor classified as a deactivation target, and stopping, by the controller, driving of a second motor not classified as the deactivation target and maintaining the second motor in an activation state.

According to an embodiment, the seat control method may further include ignoring, by the controller, a first additional switch input and maintaining a current state of the seat when the first additional switch input corresponding to the first motor is received. The seat control method may also include performing, by the controller, a seat location control corresponding to a second additional switch input when the second additional switch input corresponding to the second motor is received.

According to an embodiment, the seat control method may further include ignoring, by the controller, the switch input and maintaining a current state of the seat when the switch input is received from a first switch classified as a deactivation target.

According to an embodiment, the seat control method may further include identifying, by the controller, whether a motor corresponding to the switch input corresponds to the first motor when the switch input is received from a second switch which is not classified as the deactivation target or classified as an activation target. The seat control method may also include ignoring, by the controller, the switch input and maintaining the current state of the seat when the switch input received from the second switch corresponds to the first motor.

According to an embodiment, the seat control method may include performing, by the controller, a seat location control corresponding to a switch input by using the second motor when the switch input received from the second switch corresponds to the second motor.

According to an embodiment, the seat control method may further include identifying, by the controller, whether a recliner is unfixed, by using the sensor part disposed on one area being adjacent to the recliner for adjusting an angle of a backrest of the seat. The seat control method may also include identifying, by the controller, whether the escape mechanism is operated when it is identified that the recliner is unfixed.

According to an embodiment, the seat control method may include identifying, by the controller, whether a user setting regarding a cooperation request mode is an on state. The seat control method may also include identifying, by the controller, whether a travel speed of a host vehicle and an operation state of a collision detecting sensor included in the sensor part satisfy specific conditions when the user setting is an on state. The seat control method may additionally include transmitting, by the controller, at least one door unlocking or opening request signal of the host vehicle to an external device when the travel speed and the operation state of the collision detecting sensor satisfy the specific conditions.

According to an embodiment, the seat control method may further include transmitting, by the controller, an output request signal of an audio regarding the escape mechanism to a sound output device or transmitting an accident occurrence identification request signal to an e-call system when it is identified that the escape mechanism is operated.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram illustrating components of a seat control apparatus, according to an embodiment of the present disclosure;

FIG. 2 is a view illustrating a perspective of an operation of an escape mechanism, according to an embodiment of the present disclosure;

FIG. 3 is a block diagram illustrating components of a seat control apparatus, according to an embodiment of the present disclosure;

FIG. 4 is a flowchart of a seat control method, according to an embodiment of the present disclosure;

FIG. 5 is a flowchart of a seat control method, according to another embodiment of the present disclosure;

FIG. 6 is a flowchart of a seat control method, according to yet another embodiment of the present disclosure;

FIG. 7 is a flowchart of a seat control method, according to still another embodiment of the present disclosure;

FIG. 8 is a flowchart of a seat control method, according to yet another embodiment of the present disclosure; and

FIG. 9 illustrates a computing system that may implement a seat control method, according to an embodiment of the present disclosure.

In relation to a description of the drawings, the same or similar components may be denoted by the same or similar reference numerals.

### DETAILED DESCRIPTION

Hereinafter, embodiments of the present disclosure are be described in detail with reference to the accompanying drawings.

In adding reference numerals to the components of the drawings, it is noted that the same components are denoted by the same reference numerals even when the components are illustrated in different drawings. Furthermore, in describing the embodiments of the present disclosure, when it was determined that a detailed description of related known configurations and functions may hinder understanding of the embodiments of the present disclosure, a detailed description thereof has been omitted.

In describing the components of the embodiments of the present disclosure, terms, such as first, second, “A”, “B”, (a), and (b) may be used. These terms are simply for distinguishing the components. The essence, the sequence, and the order of the corresponding components are not limited by the terms. Unless defined differently, all the terms including technical or scientific terms have the same meanings as those generally understood by those having ordinary skill in the art to which the present disclosure pertains. The terms, such as the terms defined in dictionaries, which are generally used, should be construed to be consistent with the context meanings of the related technologies. The terms should not be construed as ideal or excessively formal meanings unless explicitly defined in the present disclosure.

When a component, device, element, or the like of the present disclosure is described as having a purpose or performing an operation, function, or the like, the component, device, or element should be considered herein as being “configured to” meet that purpose or perform that operation or function.

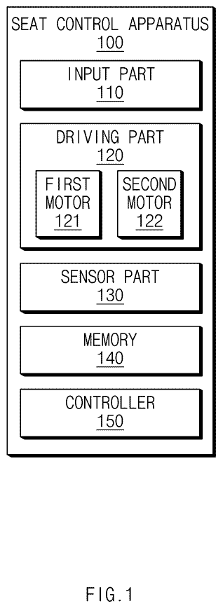

Hereinafter, embodiments of the present disclosure are described in detail with reference to FIGS. 1-9.

FIG. 1 is a block diagram illustrating components of a seat control apparatus, according to an embodiment of the present disclosure.

According to an embodiment, a seat control apparatus 100 may include at least one of an input part 110, a driving part 120, a sensor part 130, a memory 140, a controller 150, or any combination thereof. A configuration of the seat control apparatus 100 illustrated in FIG. 1 is illustrative, and the embodiments of the present disclosure are not limited thereto.

For example, the seat control apparatus 100 may further include components (e.g., at least one of an interface part, a communication part, or a sound output device, or any combination thereof) that are not illustrated in FIG. 1.

According to an embodiment, the input part 110 may include at least one switch.

For example, the input part 110 may include at least one input device (e.g., a switch and/or a touch sensor) provided in one area of a seat. The one area, as an example, may include one area of a backrest of the seat and/or one area of a side cushion of the seat.

The input part 110 may include a plurality of switches. As an example, when a switch input (e.g., a pressure input by the user) to the plurality of switches is detected, the input part 110 may provide an input signal that performs a seat location control corresponding to the corresponding switch input to the controller 150.

The seat location control may include a control operation of controlling a location of the seat in an operation mode including at least one of a walk-in mode (or an easy entry mode), a tip (or up) and slide mode, a slide and go mode, a double folding mode, a stand-up mode, or any combination thereof.

In an example, the seat location control may further include a control operation of controlling the location of the seat to restore the mode of the seat from the above-described operation mode to an original state.

In an example, when detecting (or receiving) a switch input to a specific switch among the plurality of switches included in the input part 110, the seat control apparatus 100 may perform a location control of the seat by performing, among operations according to the above-described seat location control, an operation corresponding to the switch input to the specific switch.

In an example, the plurality of switches included in the input part 110 may include a first switch that is classified as a deactivation target and a second switch that is not classified as the deactivation target or is classified as an activation target.

As an example, the first switch may include one or more automatic switches. When receiving a switch input to at least some of the automatic switches included in the first switch in a situation in which the state of the seat is in an activation state (or a situation in which at least one motor for a location control of the seat is in an activation state), the controller 150 may automatically control the location of the seat in a predefined operation mode (e.g., at least one of the walk-in mode, the double folding mode, or any combination thereof) by using at least one motor. The corresponding switch input may be a single touch input to at least some of the automatic switches. When receiving a switch input to at least some of the automatic switches included in the first switch in a situation in which the state of the seat is in a deactivation state (or a situation in which at least one motor included in the seat is in a deactivation state when the escape mechanism is operated), the controller 150 may ignore the corresponding switch input and maintain a current state of the seat.

In an example, the second switch may include one or more manual switches. When receiving a switch input to at least some of manual switches included in the second switch in a situation in which the state of the seat is an activation state (or a situation in which at least one motor for a location control of the seat is in an activation state), the controller 150 may perform a seat location control corresponding to a switch input by using at least one motor. In this case, the controller 150 may perform a seat location control (e.g., adjustment of an angle of a recliner and/or adjustment of a slide location) corresponding to a corresponding switch input while the switch input (e.g., a pressure input) to the manual switch is maintained. When receiving a switch input to at least some of the manual switches included in the second switch in a situation in which the state of the seat is in a deactivation state (or a situation in which at least one motor included in the seat is in a deactivation state when the escape mechanism is operated), the controller 150 may identify a type of a motor that is to be used to perform a seat location control in accordance with the corresponding switch input. For example, when the motor corresponding to the switch input is a first motor 121 that is classified as a deactivation target, the corresponding switch input may be ignored and the current state of the seat may be maintained. As another example, when the motor corresponding to the switch input is a second motor 122 that is not classified as a deactivation target, the seat location control corresponding to the corresponding switch input may be performed by using the second motor 122.

According to an embodiment, the driving part 120 may include at least one driving device that controls the location of the seat, and a fixing part.

In an example, the driving part 120 may perform a seat location control by using the driving device including at least one of a recliner, a slide location control device, a seat cushion angle adjusting device, or any combination thereof. The driving device, for example, may include at least one motor. The at least one motor, for example, may electrically adjust at least one of a reclining angle (or an angle of the backrest), a slide location, a seat cushion angle of the seat, or any combination thereof.

The at least one motor may include a first motor 121 that is classified as a deactivation target, and a second motor 122 that is not classified as a deactivation target. A reference for classifying the deactivation target may be determined according to a setting by the user and/or a setting by a developer/manufacturer.

The driving part 120 may include the fixing part. The fixing part may fix the at least one driving device. The fixing part, for example, may fix the recliner to one area of a side surface of the seat such that the recliner disposed in the one area of the side surface of the seat normally adjusts the reclining angle.

The fixing part may include at least one of a lever, a cable, at least one link, or any combination thereof. As an example, the cable connected to the lever may be pulled when the user pulls the lever, a second link that is engaged with the first link may be rotated together with the first link when the first link connected to the cable is rotated, and a third link that is engaged with the second link and is configured to fix the recliner may be rotated as the second link is rotated. Then, a force that fixes the recliner is released while the third link is rotated.

Accordingly, the backrest of the seat is rotated to a front side by a spring force. In an example, the controller 150 may identify that the recliner is unfixed using at least one sensor, among sensors included in the sensor part 130, (e.g., an emergency escape mechanism operation identifying sensor) that is disposed in one area that is adjacent to the recliner for adjusting an angle of the backrest of the seat, and/or a switch that is disposed in one area between the third link and the recliner. The controller 150 may identify that the escape mechanism is operated when identifying the corresponding situation. For example, the escape mechanism may include a mechanical escape mechanism. The mechanical escape mechanism may be activated, for example, by unfixing a recliner mounted on the seat.

According to an embodiment, the sensor part 130 may include at least one sensor and/or switch that identifies various pieces of information on the operation state of the seat.

For example, the sensor part 130 may identify whether the escape mechanism for the seat is operated. The sensor part 130, for example, may include at least one sensor (or a switch) (e.g., the emergent escape mechanism operation identifying sensor) that is disposed in an area that is adjacent to the driving part 120 (e.g., the recliner) that performs a seat location control.

For example, the sensor part 130 may identify whether the driving part 120 is unfixed. As an example, the sensor part 130 may identify whether various components (e.g., the at least one link) that are disposed to be engaged with the driving part 120 are rotated and/or fastened. The sensor part 130 may identify whether the escape mechanism for the seat is operated based on the identification result.

The sensor part 130 may further include a collision detecting sensor. As an example, the seat control apparatus 100 may identify whether a host vehicle collides with an external object (or there is a possibility of collision) based on an operation state of the collision detecting sensor.

In an example, when an operation state of the collision detecting sensor included in the sensor part 130 satisfies a specific condition (e.g., when the collision detecting sensor is in an on state) in a situation in which a travel speed of the host vehicle is a specific speed or less, the controller 150 may perform a cooperative control, such that the user promptly escapes from the host vehicle, by transmitting an unlocking and/or opening request signal of at least one door of the host vehicle to an external device (e.g., a door control device). The cooperative control may be performed only when the user setting regarding the cooperation request mode is an on state.

According to an embodiment, the memory 140 may store commands and/or data. For example, the memory 140 may store one or more instructions that, when executed by the controller 150, cause the seat control apparatus 100 to perform various operations.

In an embodiment, the memory 140 may be implemented in one chip with the controller 150. The controller 150 may include at least one of a communication processor or a modem.

According to an embodiment, the controller 150 may be operatively connected to at least one of the input part 110, the driving part 120, the sensor part 130, the memory 140, or any combination thereof. For example, the controller 150 may control an operation of at least one of the input part 110, the driving part 120, the sensor part 130, the memory 140, or any combination thereof.

In an embodiment, the controller 150 may receive a switch input for controlling the seat from the user through the input part 110.

The controller 150 may identify that a switch input for controlling the seat is received from the user when receiving a pressure input to at least one switch among the plurality of switches included in the input part 110.

In an embodiment, the controller 150 may identify at least one of a type of a switch corresponding to a switch input, a type of a motor that is to be used to perform a seat location control corresponding to the switch input, or any combination thereof, when receiving the switch input.

The controller 150 may also identify whether the escape mechanism for the seat is operated, by using the sensor part 130.

As an example, the controller 150 may identify whether various components (e.g., at least one link) of the fixing part, which are disposed to be engaged with at least one driving device (e.g., the recliner) included in the driving part 120 are rotated and/or fastened, by using the sensor part 130, and may identify whether the escape mechanism for the seat is operated based on the identification result. The controller 150, for example, may identify that the escape mechanism is operated when the recliner of the seat is unfixed as the components of the fixing part disposed to be engaged with the driving part 120 are rotated.

In an embodiment, the controller 150 may be configured to stop driving of at least one motor included in the driving part 120 when the escape mechanism is operated.

The controller 150 may classify the motor into a plurality of types, and may transmit different control signals according to the types thereof. The controller 150, for example, may deactivate, among the at least one motor, the first motor 121 that is classified as the deactivation target, and may maintain the second motor 122 in an activation state while stopping driving of the second 122 motor that is not classified as the deactivation target when a switch input for the seat location control is received from the user and the escape mechanism for the seat is operated.

An operation of deactivating the first motor 121 may include operations that may be performed by the controller 150.

The operations may include identifying that the first motor 121 is classified as the deactivation target even when the switch input corresponding to the seat location control that requires driving of the first motor 121 is received (or a seat location control input signal that requires driving of the first motor 121 is received), ignoring the corresponding switch input, and maintaining the current state of the seat. For example, when receiving the first additional switch input corresponding to the first motor 121 after deactivating the first motor 121, the controller 150 may ignore the first additional switch input and maintain the current state of the seat.

An operation of stopping the driving of the second motor 122 and maintaining the second motor 122 in an activation state may, for example, include an operation of stopping the driving of the second motor 122 first when it is identified that the escape mechanism is operated while the second motor 122 is driven, and performing a seat location control corresponding to the corresponding switch input by using the second motor 122 when a switch input corresponding to the seat location control that requires the driving of the second motor 122 is received (or when the seat location control input signal that requires the driving of the second motor 122 is received). For example, when the driving of the second motor 122 is stopped and is maintained in the activation state, and the second additional switch input corresponding to the second motor 122 is received, the controller 150 may perform the seat location control corresponding to the second additional switch input.

In an embodiment, the controller 150 may further determine whether the switch input is to be ignored or the seat location control corresponding to the switch input is to be performed, according to the type of the switch for applying a pressure by the user.

As an example, when the switch input is received from the first switch classified as the deactivation target, the controller 150 may ignore the switch input and maintain the current state of the seat. In other words, when the user applies a pressure input to the first switch classified as the deactivation target, the switch input may be ignored regardless of the type of the motor that requires driving in correspondence to the switch input to the first switch.

As another example, when the switch input is received from the second switch that is not classified as the deactivation target or classified as the activation target, the controller 150 may determine whether a seat location control is to be performed, based on whether the motor corresponding to the switch input corresponds the first motor 121 classified as the deactivation target. In an embodiment, the second switch may include at least one switch that is not classified as the deactivation target or the activation target and at least one switch that is classified as the activation target. The controller 150 may ignore a switch input and maintain the current state of the seat when the switch input received from the second switch corresponds to the first motor 121. The controller 150 may perform a seat location control corresponding to the switch input by using the second motor 122 when the switch input received from the second switch corresponds to the second motor 122.

For example, the controller 150 may perform a cooperative control, such that the user may promptly escape, by transmitting an unlocking or opening request signal of at least one door (e.g., at least one of a rear door, a front door, a door window, an electric curtain, a tail gate, or any combination thereof) of the host vehicle.

In an embodiment, the controller 150 may identify whether a user setting of the cooperation request mode is an on state, and may identify whether the travel speed of the host vehicle and an operation of the collision detecting sensor included in the sensor part 130 satisfy a specific condition when the user setting is an on state. When the travel speed and the operation state of the collision detecting sensor satisfy the specific condition, the controller 150 may transmit at least one door unlocking or opening request signal of the host vehicle to an external device (e.g., a door control device). The specific condition, for example, may include a condition, in which the travel speed is a specific speed (e.g., 3 km/h) or less and the operation state of the collision detecting sensor is an on state.

In an embodiment, the controller 150 may provide information on a current travel situation of the host vehicle to the user by using at least one notification device when identifying that the escape mechanism is operated.

As another embodiment, the controller 150 may transmit an output request signal of an audio regarding the escape mechanism to the sound output device when identifying that the escape mechanism is operated. The user may receive information on at least one of an operation situation of the escape mechanism, a travel situation of the host vehicle, or any combination thereof, through an audio that is output by the sound output device based on the received request signal of the audio.

As another embodiment, the controller 150 may transmit an accident occurrence identification request signal to an e-call system when identifying that the escape mechanism is operated.

The user may receive information on at least one of an operation situation of the escape mechanism, a travel situation of the host vehicle, or any combination thereof, through information (e.g., visual and/or audible contents) that may be output by the e-call system based on the received accident occurrence identification request signal.

The controller 150 may perform a seat location control corresponding to a switch input by using at least one motor included in the driving part 120 when the escape mechanism is not operated.

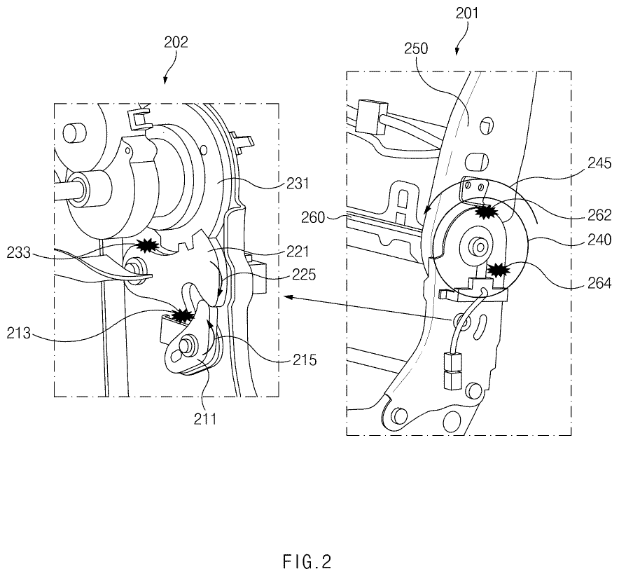

FIG. 2 is a conceptual view illustrating a perspective of an operation of the escape mechanism, according to an embodiment of the present disclosure.

Referring to a view 201, according to an embodiment, a seat control apparatus (e.g., the seat control apparatus 100 of FIG. 1) may perform an operation of adjusting an angle of a backrest for seat location control by using a driving part (e.g., the driving part 120 of FIG. 1) including a recliner 240 and a reclining motor 250. As the recliner 240 is rotated together with a shaft 260 through driving of the reclining motor 250, the angle of the backrest of the seat may be adjusted.

For example, the seat control apparatus may adjust the angle of the backrest of the seat by driving the reclining motor 250 and thus rotating the recliner 240 and the shaft 260 when receiving a switch input for adjusting the angle of the backrest through an input part (e.g., the input part 110 of FIG. 1).

Referring to a view 202, according to an embodiment, the seat control apparatus may fix the recliner 240 to one area of a side surface of the seat by using the fixing part including at least one link 211, 221, and/or 231.

In another embodiment, the fixing part may further include a lever and a cable. As an example, when the user pulls the lever for an operation of an escape mechanism, the first link 211 connected to the cable may be rotated in a first direction 215 while the cable connected to the lever is pulled. Then, while the second link 221 engaged with the first link 211 is rotated in a second direction 225, a portion of the first link 211 and a portion of the second link 221 may be coupled to each other at a first portion 213. Then, a second portion 233 that fixes the recliner 240 while the third link 231 is rotated through rotation of the second link 221 may be separated. Thus, the recliner 240 for the one area of the side surface of the seat may be unfixed.

When the recliner 240 is unfixed, the recliner 240 may be rotated in a third direction 245 (or a forward direction) while a spring included in the fixing part is decompressed. Accordingly, the user who is seated on a rear seat of the seat illustrated in FIG. 2 may escape to an outside of the host vehicle.

The seat control apparatus may identify that the fixing of the recliner 240 through the fixing part is released, by using a sensor part (e.g., the sensor part 130 of FIG. 1). As an example, the seat control apparatus may identify that the recliner 240 is unfixed, by using at least one sensor and/or a switch included in an area in which some of the parts included in the recliner 240 are disposed to be engaged with each other. The seat control apparatus, for example, may identify whether the recliner 240 is unfixed, through the sensor and/or the switch disposed in a first area 262 and/or a second area 264.

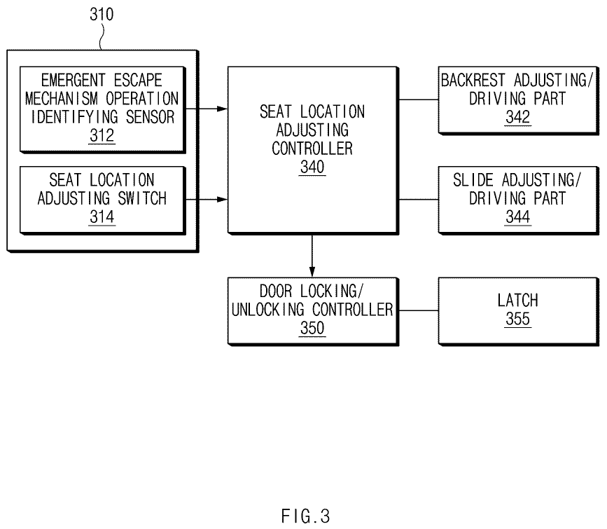

FIG. 3 is a block diagram illustrating components of a seat control apparatus, according to an embodiment of the present disclosure.

Referring to FIG. 3, according to an embodiment, a seat control apparatus (e.g., the seat control apparatus 100 of FIG. 1) may include at least one of emergent escape mechanism operation identifying sensor 312 (e.g., the sensor part 130 of FIG. 1), a seat location adjusting switch 314 (e.g., the input part 110 of FIG. 1), a seat location adjusting controller 340 (e.g., the controller 150 of FIG. 1), a backrest adjusting/driving part 342, a slide adjusting/driving part 344, a door locking/unlocking controller 350, a latch 355, or any combination thereof.

The seat control apparatus may include a seat state control device 310 including the emergent escape mechanism operation identifying sensor 312 and the seat location adjusting switch 314.

The seat control apparatus may identify whether the escape mechanism for the seat is operated, by using the emergent escape mechanism operation identifying sensor 312. For example, the seat control apparatus may identify that the escape mechanism for the seat is operated when identifying that a driving part (e.g., the driving part 120) (or the backrest adjusting/driving part 342) for the seat is unfixed, by using the emergent escape mechanism operation identifying sensor 312.

In an embodiment, the seat control apparatus may receive, for the user, a switch input for a seat location control by using the seat location adjusting switch 314.

The seat control apparatus may perform a seat location control by using the seat location adjusting controller 340. For example, the seat control apparatus may control an operation state of the at least one motor included in the driving part, and may provide a specific cooperation request signal to a door locking/unlocking controller. Although FIG. 3 illustrates that the door locking/unlocking controller 350 and the latch 355 constitute one component of the seat control apparatus, the door locking/unlocking controller 350 and the latch 355 may be separate external devices that are distinguished from the seat control apparatus.

In an embodiment, the seat control apparatus may receive signals provided by the emergent escape mechanism operation identifying sensor 312 and the seat location adjusting switch 314 through the seat location adjusting controller 340, and may perform a seat location control based on the received signals.

The seat control apparatus may control an operation state of at least one motor included in the driving part. The seat control apparatus may also provide a specific cooperation request signal to a door locking/unlocking controller.

In an embodiment, the seat location adjusting controller 340 may receive a switch input from the seat location adjusting switch 314, and may provide a control signal to the backrest adjusting/driving part 342 and/or the slide adjusting/driving part 344 for the seat location control corresponding to the received switch input.

The seat location adjusting controller 340 may stop driving of at least one motor included in the backrest adjusting/driving part 342 and/or the slide adjusting/driving part 344 when receiving a signal indicating that the escape mechanism for the seat is operated from the emergent escape mechanism operation identifying sensor 312. The seat location adjusting controller 340 may control the operation state of, among the at least one motor, a motor that is classified as a deactivation target to a deactivation state.

In an embodiment, the seat location adjusting controller 340 may provide a cooperation request signal to the door locking/unlocking controller 350 when receiving a signal indicating that the escape mechanism for the seat is operated from the emergent escape mechanism operation identifying sensor 312. The seat location adjusting controller 340 may provide a cooperation request signal only when a user setting regarding the cooperation request mode is an on state. For example, when the user setting is an on state, the seat location adjusting controller 340 may identify whether the travel speed of the host vehicle and the operation state of the collision detecting sensor included in the sensor part satisfy a specific condition. When the travel speed and the operation state of the collision detecting sensor satisfy the specific condition, the controller 340 may transmit at least one door unlocking or opening request signal of the host vehicle to the door locking/unlocking controller 350.

The door locking/unlocking controller 350 may control the latch 355 to unlock and open the at least one door of the host vehicle, based on the received door unlocking or opening request signal.

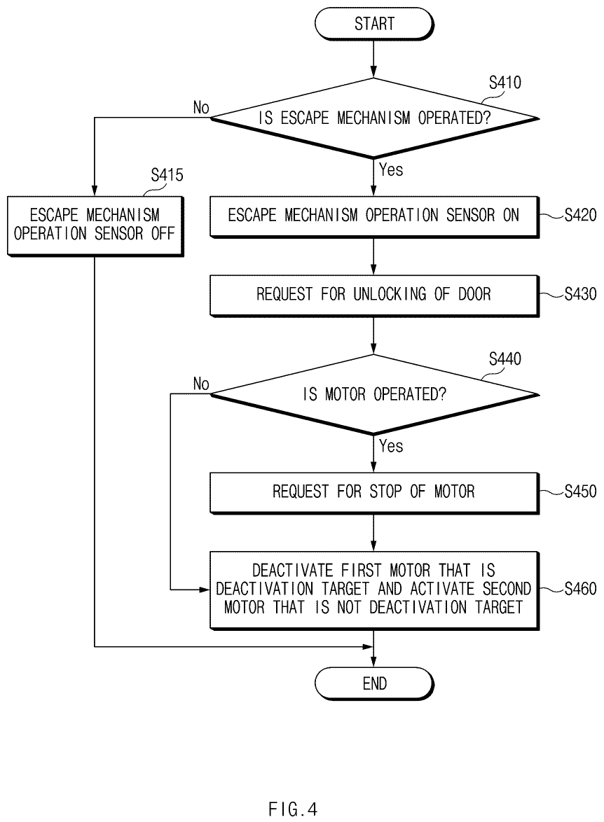

FIG. 4 is a flowchart of a seat control method, according to an embodiment of the present disclosure.

According to an embodiment, a seat control apparatus (e.g., the seat control apparatus 100 of FIG. 1) may perform operations disclosed in FIG. 4. For example, at least some of the components (e.g., at least one of the input part 110, the driving part 120, the sensor part 130, the memory 140, or the controller 150, or any combination thereof) included in the seat control apparatus may be configured to perform the operations of FIG. 4.

In an embodiment, operations S410-S460 illustrated in FIG. 4 may be performed sequentially. In another embodiment, the operations S410-S460 are not necessarily performed sequentially. For example, a sequence of the operations may be changed and/or at least two operations may be performed in parallel. It is noted that contents corresponding to the contents described above or repeated contents may have been described briefly below in connection with FIG. 4, or may have been omitted from the description below in connection with FIG. 4.

In an operation S410, the escape mechanism for the seat may be operated.

For example, the user may be provided with an escape mechanism function by which the recliner is unfixed through rotation of at least one link by pulling the lever disposed in one area of the seat.

When the escape mechanism for the seat is operated (e.g., Yes in the operations S410), the seat control apparatus may perform an operation S420.

On the other hand, when the escape mechanism for the seat is not operated (or when the seat is operated in a general operation state) (e.g., No in the operation S410), the seat control apparatus may perform an operation S415.

In the operation S415, the seat control apparatus may identify whether the escape mechanism operation sensor is off.

For example, the seat control apparatus may identify that the escape mechanism for the seat is not operated based on identifying that an operation state of the at least one escape mechanism operation sensor disposed in one area of a location, to which the recliner is fixed by using a plurality of parts, is off.

In the operation S420, the seat control apparatus may identify that the escape mechanism operation sensor is in an on state.

For example, the seat control apparatus may identify that the escape mechanism for the seat is operated based on identifying that the operation state of the at least one escape mechanism operation sensor disposed in one area of a location, to which the recliner is fixed by using the plurality of parts, is an on state.

In an operation S430, the seat control apparatus may transmit a door unlocking request.

For example, the seat control apparatus may transmit a door unlocking request signal to the door control device. The seat control apparatus, for example, may identify whether a user setting regarding a cooperation request mode is an on state. The seat control apparatus may also identify whether the travel speed of the host vehicle and the operation state of the collision detecting sensor included in the sensor part satisfy a specific condition when the user setting is the on state. The seat control apparatus may then transmit at least one door unlocking or opening request signal of the host vehicle to an external device when the travel speed and the operation state of the collision detecting sensor satisfies the specific condition.

In an operation S440, the seat control apparatus may identify whether a motor is operated.

For example, the seat control apparatus may identify whether at least one motor for a seat location control is operated (or driven).

When the motor is operated (e.g., Yes in the operation S440), the seat control apparatus may perform an operation S450.

On the other hand, when the motor is not operated (e.g., No in the operation S440), the seat control apparatus may perform an operation S460.

In the operation S450, the seat control apparatus may deliver a motor stop request.

For example, the seat control apparatus may provide the motor stop request to the driving part to stop the driving of the motor.
in the operation S460, the seat control apparatus may deactivate a first motor that is a deactivation target, and may activate a second motor that is not a deactivation target into a non-operation state.

For example, the seat control apparatus may deactivate, among the at least one motor, the first motor classified as the deactivation target, and may stop the driving of the second motor not classified as the deactivation target and maintain the activation state.

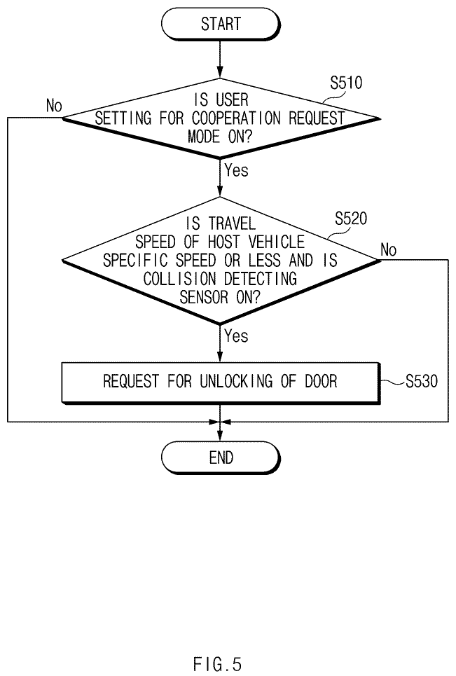

FIG. 5 is a flowchart of a seat control method, according to an embodiment of the present disclosure.

According to an embodiment, a seat control apparatus (e.g., the seat control apparatus 100 of FIG. 1) may perform operations disclosed in FIG. 5. For example, at least some of the components (e.g., at least one of the input part 110, the driving part 120, the sensor part 130, the memory 140, or the controller 150, or any combination thereof) included in the seat control apparatus may be configured to perform operations of FIG. 5.

In an embodiment, operations S510-S530 illustrated in FIG. may be sequentially performed. In another embodiment, the operations S510-S530 are not necessarily sequentially performed.

For example, a sequence of the operations may be changed and/or at least two operations may be performed in parallel. It is noted that contents corresponding to the contents described above or repeated contents may have been described briefly below in connection with FIG. 5, or may have been omitted from the description below in connection with FIG. 5.

In an operation S510, it may be identified whether a user setting regarding a seat control cooperation request mode is an on state.

When it is identified that the user setting regarding the cooperation request mode is an on state (e.g., Yes in the operation S510), the seat control apparatus may perform an operation S520.

On the other hand, when it is identified that the user setting regarding the cooperation request mode is not an on state (or when it is identified that the user setting is an off state) (e.g., No in the operation S510), the seat control apparatus may end the operation.

In the operation S520, the seat control apparatus may identify whether the travel speed of the host vehicle is a specific speed or less and the operation state of the collision detecting sensor is an on state.

When the travel speed of the host vehicle is the specific speed or less and the operation state of the collision detecting sensor is an on state (e.g., Yes in the operation S520), the seat control apparatus may perform an operation S530.

On the other hand, when the travel speed of the host vehicle is more than the specific speed or the operation state of the collision detecting sensor is not an on state (e.g., No in the operation S520), the seat control apparatus may end the operation.

In the operation S530, the seat control apparatus may transmit a door unlocking request.

For example, the seat control apparatus may transmit at least one door unlocking or opening request signal of the host vehicle to an external device (e.g., the door control device).

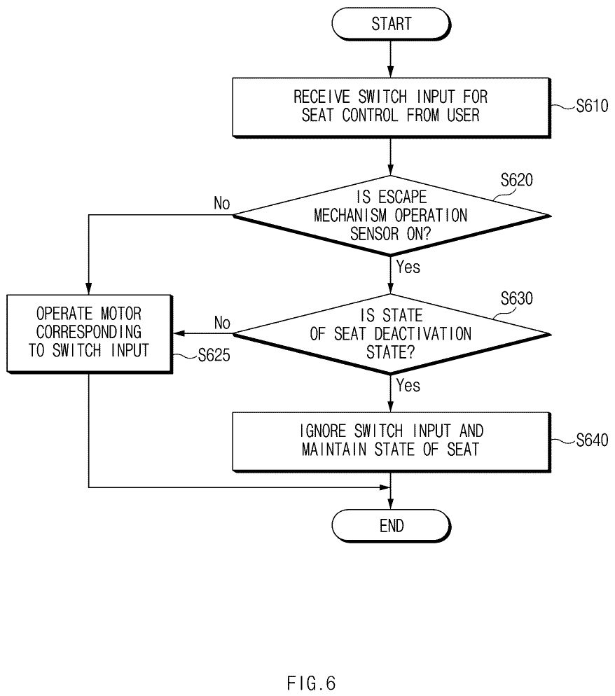

FIG. 6 is a flowchart of a seat control method, according to an embodiment of the present disclosure.

According to an embodiment, a seat control apparatus (e.g., the seat control apparatus 100 of FIG. 1) may perform operations disclosed in FIG. 6. For example, at least some of the components (e.g., at least one of the input part 110, the driving part 120, the sensor part 130, the memory 140, or the controller 150, or any combination thereof) included in the seat control apparatus may be configured to perform operations of FIG. 6.

In an embodiment, operations S610-S640 illustrated in FIG. 6 may be sequentially performed, In another embodiment, the operations S610-S640 are not necessarily sequentially performed.

For example, a sequence of the operations may be changed and/or at least two operations may be performed in parallel. It is noted that contents corresponding to the contents described above or repeated contents may have been described briefly below in connection with FIG. 6, or may have been omitted from the description below in connection with FIG. 6.

In an operation S610, the seat control apparatus may receive a switch input for controlling the seat from the user.

In an operation S620, the seat control apparatus may identify whether an escape mechanism operation sensor is in an on state.

When identifying that the escape mechanism operation sensor is in an on state (e.g., Yes in the operation S620), the seat control apparatus may perform an operation S630.

On the other hand, when identifying that the escape mechanism operation sensor is not in an on state (or identifying that the escape mechanism operation sensor is in an off state) (e.g., No in the operation S620), the seat control apparatus may perform an operation S625.

In the operation S630, the seat control apparatus may identify whether the state of the seat is a deactivation state.

When identifying that the state of the seat is a deactivation state (e.g., Yes in the operation S630), the seat control apparatus may perform an operation S640.

On the other hand, when identifying that the state of the seat is a deactivation state (or identifying that the state of the seat is an activation state) (e.g., No in the operation S630), the seat control apparatus may perform the operation S625.

In the operation S640, the seat control apparatus may ignore a switch input, and may maintain a current state of the seat.

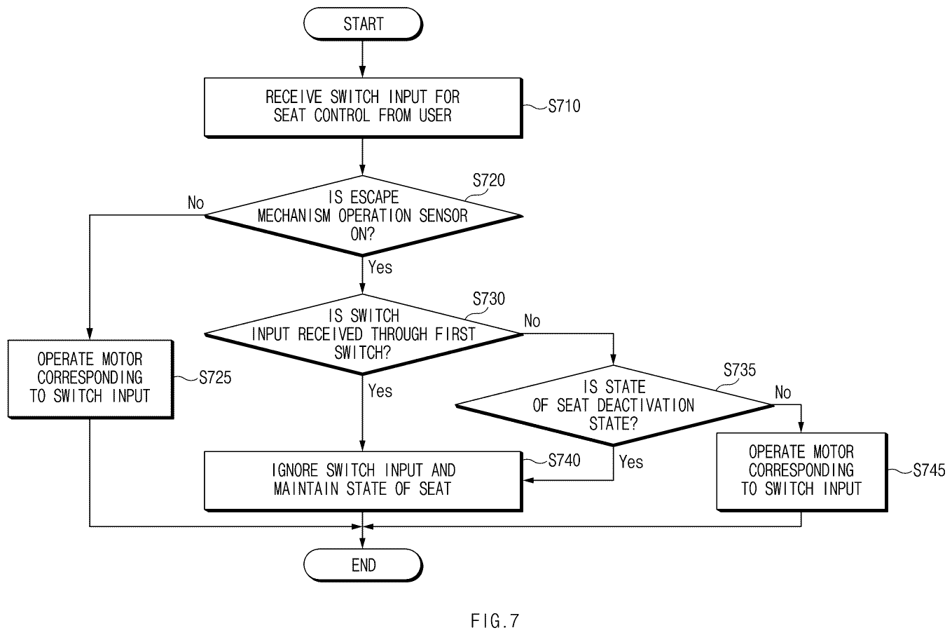

FIG. 7 is a flowchart of a seat control method, according to an embodiment of the present disclosure.

According to an embodiment, a seat control apparatus (e.g., the seat control apparatus 100 of FIG. 1) may perform operations disclosed in FIG. 7. For example, at least some of the components (e.g., at least one of the input part 110, the driving part 120, the sensor part 130, the memory 140, or the controller 150, or any combination thereof) included in the seat control apparatus may be configured to perform operations of FIG. 7.

In an embodiment, operations S710-S745 illustrated in FIG. 7 may be sequentially performed. In another embodiment, the operations S710-S745 are not necessarily sequentially performed.

For example, a sequence of the operations may be changed and/or at least two operations may be performed in parallel. It is notes that contents corresponding to the contents described above or repeated contents may have been described briefly below in connection with FIG. 7, or may have been omitted from the description below in connection with FIG. 7.

In an operation S710, the seat control apparatus may receive a switch input for controlling the seat from the user.

In an operation S720, the seat control apparatus may identify whether the escape mechanism operation sensor is in an on state.

When identifying that the escape mechanism operation sensor is in an on state (e.g., Yes in the operation S720), the seat control apparatus may perform an operation S730.

On the other hand, when identifying that the escape mechanism operation sensor is not in an on state (or when identifying that the escape mechanism operation sensor is in an off state) (e.g., No in the operation S720), the seat control apparatus may perform an operation S725.

In the operation S725, the seat control apparatus may operate a motor corresponding to a switch input.

For example, the seat control apparatus may operate at least one motor that is to be driven for a seat location control corresponding to the switch input.

In the operation S730, the seat control apparatus may identify whether a switch input is received through a first switch.

For example, the seat control apparatus may identify whether the switch input is received through, among at least one switch, the first switch classified as a deactivation target during an operation of the escape mechanism.

When receiving the switch input through the first switch (e.g., Yes in the operation S730), the seat control apparatus may perform an operation S740.

On the other hand, when identifying that a switch input is not received through the first switch (or when identifying that the switch input is received through the second switch) (e.g., No in the operation S730), the seat control apparatus may perform an operation S735.

In the operation S735, the seat control apparatus may identify whether the state of the seat is a deactivation state.

For example, the seat control apparatus may identify whether a motor that is to be driven for a seat location control corresponding to the switch input corresponds to the motor classified as a deactivation target.

When the state of the seat is a deactivation state (or a motor that is to be driven for a seat location control corresponding to the switch input is a motor classified as a deactivation target) (e.g., Yes in the operation S735), the seat control apparatus may perform an operation S740.

On the other hand, when the state of the seat is not a deactivation state (or a motor that is to be driven for a seat location control corresponding to the switch input is not a motor classified as a deactivation target (e.g., No in the operation S735), the seat control apparatus may perform an operation S745.

In the operation S740, the seat control apparatus may ignore the switch input and maintain the state of the seat.

In the operation S745, the seat control apparatus may operate a motor corresponding to the switch input.

For example, the seat control apparatus may perform a seat location control corresponding to a switch input, by operating a motor that is to be driven for a seat location control corresponding to the switch input.

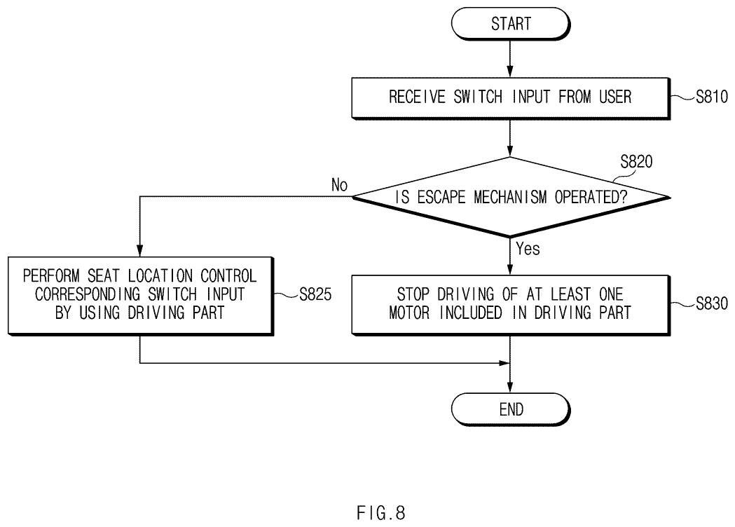

FIG. 8 is a flowchart of a seat control method, according to an embodiment of the present disclosure.

According to an embodiment, a seat control apparatus (e.g., the seat control apparatus 100 of FIG. 1) may perform operations disclosed in FIG. 8. For example, at least some of the components (e.g., at least one of the input part 110, the driving part 120, the sensor part 130, the memory 140, or the controller 150, or any combination thereof) included in the seat control apparatus may be configured to perform operations of FIG. 8.

In an embodiment, operations S810-S830 illustrated in FIG. 8 may be sequentially performed. In another embodiment, the operations S810-S830 are not necessarily sequentially performed.

For example, a sequence of the operations may be changed and/or at least two operations may be performed in parallel. It is noted that contents corresponding to the contents described above or repeated contents may have been described briefly below in connection with FIG. 8, or may have been omitted from the description below in connection with FIG. 8.

In an operation S810, the seat control apparatus may receive a switch input for controlling a seat from the user.

In an operation S820, the seat control apparatus may identify whether an escape mechanism is operated.

For example, the seat control apparatus may identify whether the escape mechanism for the seat is operated, by using the sensor part.

When the escape mechanism for the seat is operated (e.g., Yes in the operation S820), the seat control apparatus may perform an operation S830.

On the other hand, when identifying that the escape mechanism for the seat is not operated (e.g., No in the operation S820), the seat control apparatus may perform an operation S825.

In the operation S825, the seat control apparatus may perform a seat location control corresponding to the switch input, by using the driving part.

For example, the seat control apparatus may perform a seat location control corresponding to a switch input by driving at least one motor such that a location of the seat is changed to a seat operation mode corresponding to the switch input.

In the operation S830, the seat control apparatus may stop driving of at least one motor included in the driving part.

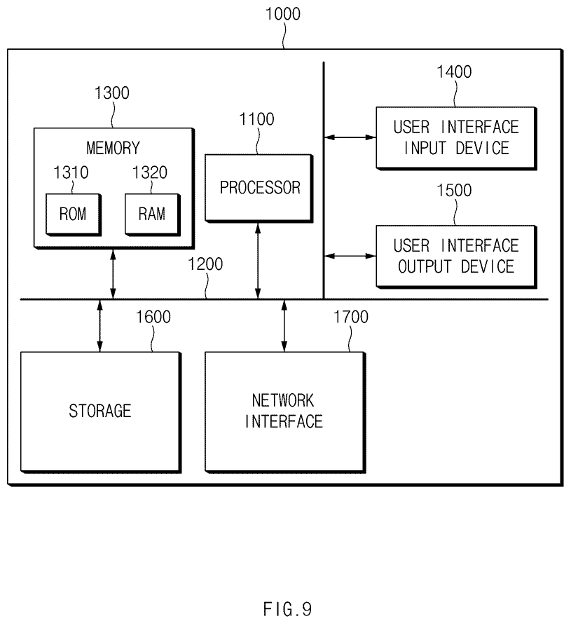

FIG. 9 illustrates a computing system that may implement a seat control method, according to an embodiment of the present disclosure.

Referring to FIG. 9, a computing system 1000 that may implement the seat control method may include at least one processor 1100, a memory 1300, a user interface input device 1400, a user interface output device 1500, a storage 1600, and a network interface 1700, which are connected through a system bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the operations or steps of the method or algorithm described in relation to the embodiments of the present disclosure may be implemented directly by hardware executed by the processor 1100, a software module, or a combination thereof.

The software module may reside in a storage medium (that is, the memory 1300 and/or the storage 1600), such as a RAM, a flash memory, a ROM, an EPROM, an EEPROM, a register, a hard disk, a solid state drive (SSD), a detachable disk, or a CD-ROM.

The storage medium is coupled to the processor 1100, and the processor 1100 may read information from the storage medium and may write information in the storage medium. In another example, the storage medium may be integrated with the processor 1100. The processor and the storage medium may reside in an application specific integrated circuit (ASIC). The ASIC may reside in a user terminal. In another example, the processor and the storage medium may reside in the user terminal as an individual component.

Effects of the seat control apparatus and the seat control method according to embodiments of the present disclosure are described below.

According to at least one of the embodiments of the present disclosure, the seat control apparatus may perform a location control of a seat of a specific row promptly for safety of a user in a situation in which it is impossible to control the seat of the specific row (e.g., row 2) or it is difficult for the user to escape due to a very slow location control in a situation in which a host vehicle confronts an emergence situation.

Furthermore, according to at least one of the embodiments of the present disclosure, when a portion of a mechanical structure may be damaged and/or deteriorated due to frequent uses by the user, in a seat employing the escape mechanism, in particular, a seat employing the escape mechanism through mechanical constraint or release, a possibility of malfunctions may be decreased and a location control of the seat may be precisely performed for escape of the user.

In addition, various effects directly or indirectly recognized through the specification may be provided.

The above description is illustrative of the technical spirits of the present disclosure. It should be understood by those having ordinary skill in the art to which the present disclosure pertains that various, corrections and modifications may be made without departing from the technical scope of the present disclosure.

Therefore, the embodiments disclosed in the present disclosure are not for limiting the technical spirits of the present disclosure but for describing them. The scope of the technical spirits of the present disclosure is not limited by the embodiments. The scope of the present disclosure should be construed by the following claims, and all the technical changes within the equivalent scope should be construed as being included in the scope of the present disclosure.

What is claimed is:

1. A seat control apparatus, comprising:
an input part;
a driving part;
a sensor part;
a memory configured to store one or more instructions; and
a controller operatively connected to the input part, the driving part, the sensor part, and the memory,
wherein the instructions, when executed by the controller, cause the seat control apparatus to:
receive, through the input part, a switch input for controlling a seat;
identify, using the sensor part, whether an escape mechanism for the seat is operated; and
stop driving of at least one motor included in the driving part when the escape mechanism is operated.

2. The seat control apparatus of claim 1, wherein the instructions, when executed by the controller, further cause the seat control apparatus to:
perform a seat location control corresponding to the switch input by using the driving part when the escape mechanism is not operated.

3. The seat control apparatus of claim 1, wherein the at least one motor includes a first motor and a second motor, and
wherein the instructions, when executed by the controller, cause the seat control apparatus to:
deactivate the first motor classified as a deactivation target; and
stop driving of the second motor not classified as the deactivation target and maintain the second motor in an activation state.

4. The seat control apparatus of claim 3, wherein the instructions, when executed by the controller, further cause the seat control apparatus to:
ignore a first additional switch input and maintain a current state of the seat when the first additional switch input corresponding to the first motor is received; and
perform a seat location control corresponding to a second additional switch input when the second additional switch input corresponding to the second motor is received.

5. The seat control apparatus of claim 3, wherein the instructions, when executed by the controller, further cause the seat control apparatus to:
ignore the switch input and maintain a current state of the seat when the switch input is received from a first switch classified as a deactivation target.

6. The seat control apparatus of claim 5, wherein the instructions, when executed by the controller, further cause the seat control apparatus to:
identify whether a motor corresponding to the switch input corresponds to the first motor when the switch input is received from a second switch which is not classified as the deactivation target or classified as an activation target; and
ignore the switch input and maintain the current state of the seat when the switch input received from the second switch corresponds to the first motor.

7. The seat control apparatus of claim 6, wherein the instructions, when executed by the controller, further cause the seat control apparatus to:
perform a seat location control corresponding to the switch input by using the second motor when the switch input received from the second switch corresponds to the second motor.

8. The seat control apparatus of claim 1, wherein the instructions, when executed by the controller, further cause the seat control apparatus to:
identify whether a recliner is unfixed, by using the sensor part disposed on one area being adjacent to the recliner for adjusting an angle of a backrest of the seat; and
identify whether the escape mechanism is operated when it is identified that the recliner is unfixed.

9. The seat control apparatus of claim 1, wherein the instructions, when executed by the controller, further cause the seat control apparatus to:
identify whether a user setting regarding a cooperation request mode is in an on state;
identify whether a travel speed of a host vehicle and an operation state of a collision detecting sensor included in the sensor part satisfy specific conditions when the user setting is the on state; and
transmit at least one door unlocking or opening request signal of the host vehicle to an external device when the travel speed and the operation state of the collision detecting sensor satisfy the specific conditions.

10. The seat control apparatus of claim 1, wherein the instructions, when executed by the controller, further cause the seat control apparatus to:
transmit an output request signal of an audio regarding the escape mechanism to a sound output device or transmit an accident occurrence identification request signal to an e-call system when it is identified that the escape mechanism is operated.

11. A seat control method, comprising:
receiving, by a controller, a switch input for controlling a seat;
identifying, by the controller, using a sensor part, whether an escape mechanism for the seat is operated; and
stopping, by the controller, driving of at least one motor included in a driving part when the escape mechanism is operated.

12. The seat control method of claim 11, further comprising:
performing, by the controller, a seat location control corresponding to the switch input by using the driving part when the escape mechanism is not operated.

13. The seat control method of claim 11, wherein the at least one motor includes a first motor and a second motor, and stopping the driving of the at least one motor included in the driving part when the escape mechanism is operated includes:
deactivating, by the controller, the first motor classified as a deactivation target; and
stopping, by the controller, driving of the second motor not classified as the deactivation target and maintaining the second motor in an activation state.

14. The seat control method of claim 13, further comprising:
ignoring, by the controller, a first additional switch input and maintaining a current state of the seat when the first additional switch input corresponding to the first motor is received; and
performing, by the controller, a seat location control corresponding to a second additional switch input when the second additional switch input corresponding to the second motor is received.

15. The seat control method of claim 13, further comprising:
ignoring, by the controller, the switch input and maintaining a current state of the seat when the switch input is received from a first switch classified as a deactivation target.

16. The seat control method of claim 15, further comprising:
identifying, by the controller, whether a motor corresponding to the switch input corresponds to the first motor when the switch input is received from a second switch which is not classified as the deactivation target or classified as an activation target; and
ignoring, by the controller, the switch input and maintaining the current state of the seat when the switch input received from the second switch corresponds to the first motor.

17. The seat control method of claim 16, further comprising:
performing, by the controller, a seat location control corresponding to the switch input by using the second motor when the switch input received from the second switch corresponds to the second motor.

18. The seat control method of claim 11, further comprising:
identifying, by the controller, whether a recliner is unfixed, by using the sensor part disposed on one area being adjacent to the recliner for adjusting an angle of a backrest of the seat; and
identifying, by the controller, whether the escape mechanism is operated when it is identified that the recliner is unfixed.

19. The seat control method of claim 11, further comprising:
identifying, by the controller, whether a user setting regarding a cooperation request mode is in an on state;
identifying, by the controller, whether a travel speed of a host vehicle and an operation state of a collision detecting sensor included in the sensor part satisfy specific conditions when the user setting is the on state; and
transmitting, by the controller, at least one door unlocking or opening request signal of the host vehicle to an external device when the travel speed and the operation state of the collision detecting sensor satisfy the specific conditions.

20. The seat control method of claim 11, further comprising:
transmitting, by the controller, an output request signal of an audio regarding the escape mechanism to a sound output device or transmitting an accident occurrence identification request signal to an e-call system when it is identified that the escape mechanism is operated.
